(19) United States
(12) Patent Application Publication
(10) Pub. No.: US 2012/0220366 A1
(43) Pub. Date: Aug. 30, 2012

(54) GAME SYSTEM

(76) Inventors: Hisayoshi Takayama, Minato-ku (JP); Hiroshi Fukuda, Minato-ku (JP); Tsuyoshi Okino, Minato-ku (JP); Yuma Takafuji, Minato-ku (JP); Takashi Ito, Minato-ku (JP); Shuichi Kura, Minato-ku (JP); Ryo Mahara, Minato-ku (JP); Kenichiro Shioda, Minato-ku (JP); Shinnosuke Miki, Minato-ku (JP); Kohei Kawauchi, Minato-ku (JP); Eiichi Yoshioka, Minato-ku (JP); Masahiro Saito, Minato-ku (JP); Noriaki Nis Nishimura, Minato-ku (JP); Ayumi Ishizawa, Minato-ku (JP)

(21) Appl. No.: 13/502,621

(22) PCT Filed: Sep. 22, 2010
(86) PCT No.: PCT/JP2010/066428

§ 371 Date: Apr. 18, 2012

(30) Foreign Application Priority Data
Oct. 20, 2009 (JP) 2009-241812

(51) Int. Cl. A63F 13/10

(52) U.S. Cl. 463/25

(57) ABSTRACT

Disclosed is a game system which is capable of matching the replay range with the replay fee, even when the replay range is set to a portion of the played range. A game system allows a user to play the game in the predetermined range when an initial fee is collected from the user, and sets the play fee necessary for playing the game in the replay range according to the setting of the replay range. After the game is over in the predetermined range, the replay process is performed for allowing the user to play the game in the replay range, on the condition that the set play fee is collected from the user.

### TECHNICAL FIELD

The present invention relates to a game system that can play a portion of the played game again for fee.

### BACKGROUND ART

There is known a game system which contests the correct answer rate etc. of quizzes between game terminals connected to each other through the network (for example, see Patent Literature 1). Patent Literature 1: Japanese Patent Application Laid-Open No. 2008-178442.

### SUMMARY OF INVENTION

### Technical Problem

In a quiz game, in some cases, the player wants to review or check the questions that the player got wrong. However, in the game system which allows the player who pays for a play fee to play the game, since it is premised that a play fee suitable for the initial play range is paid, it is necessary to charge for a service which gives the questions to the player again. However, in the quiz game, since the number of questions that the players got wrong is not constant, the problem is how to charge based on the number of questions which are given again. Therefore, there is not disclosed a game system which is capable of charging for the number of questions which are given again. This kind of problem is not limited to the quiz game, but may occur in various kinds of games in which the replay range is not determined

An object of the present invention is to provide, for example, a game system capable of matching a replay range with a replay fee even when the replay range is set to a portion of the played range.

### Solution to Problem

A game system according to the present invention comprises: a charging device that collects a play fee from a user; a game control device that allows the user to play a game in a predetermined range when the charging device collects an initial fee from the user; a replay range setting device that can set a replay range limited to a portion of the predetermined range; a replay fee setting device that sets a play fee necessary for playing the game in the replay range; an adjusting device that changes any one setting of the replay range set by the replay range setting device and the play fee set by the replay fee setting device according to the other setting of the replay range and the play fee; and a replay processing device that performs a replay process for allowing the user to play the game in the replay range set by the replay range setting device after the game is over in the predetermined range, on condition that the charging device collects the play fee set by the replay fee setting device from the user.

According to the game system of the present invention, there is provided the adjusting device which changes one of the replay range set by the replay range setting device and the play fee set by the replay fee setting device according to the other of the replay range and the play fee. Therefore, even when the replay range is set to a portion of the played range, it is possible to match the replay range with the replay fee.

In an aspect of the present invention, the game control device may be configured to advance the game in the predetermined range by a predetermined unit, the number of units of the game in the replay range may be set so as to be less than the number of units of the game in the predetermined range, and the adjusting device may change the one setting according to the other setting such that an increase in the number of units in the replay range corresponds with an increase in the play fee set by the replay fee setting device. According to this structure, it is possible to reasonably match the number of units in the replay range with the replay fee.

The game system may further comprise a result evaluating device that evaluates a play result for each unit, and wherein the replay range setting device may extract a unit with a relatively low score from the units of the game included in the predetermined range and set the replay range, and the replay fee setting device may function as the adjusting device by increasing or decreasing the play fee according to the replay range set by the replay range setting device. According to this structure, the unit with a low score is set in the replay range when the game corresponding to an initial fee is played. Therefore, for example, it is possible to improve the score by playing the game again.

In an aspect of the present invention, the game may be configured as a quiz game which uses a question and an answer of a player as the unit and progresses by the unit, the replay range setting device may extract the unit in which the answer of the player is incorrect from the units of the game included in the predetermined range and sets the replay range, and the replay fee setting device may function as the adjusting device by increasing the play fee with increasing the number of units included by the replay range setting device. In this case, the replay processing device may perform, as the replay process, a process of giving the questions included in the replay range to the player. According to these structures, the player can reconfirm the wrong questions by additionally pay for a reasonable play fee.

In an aspect of the present invention, the charging device and the game control device may be provided in a game terminal, and the replay processing device may perform a process of allowing the player to play the game in the replay range on the game terminal as the replay process. According to this structure, the player can play the game in the replay range in the place where the player paid for the initial fee and played the game.

Or, the charging device and the game control device may be provided in a game terminal, the game terminal may be connected to a server through the network, a user terminal different from the game terminal can be connected to the server through the network, and the replay processing device may perform, as the replay process, a process for allowing the user terminal to be able to play the game in the replay range. According to this structure, after the game is played on the game terminal, the game in the replay range can played on the user terminal. Therefore, flexibility in playing the game in the replay range is improved. For example, when the game terminal is provided in, for example, a commercial facility and the user terminal is a personal computer or a mobile phone of the user, the user can be away from the game terminal and play the game in the replay range at appropriate time.

The charging device may collect the play fee using an electronic payment device that can replace a cash payment device, and achieve the collection of the play fee set by the replay fee setting device only by use of the electronic payment device. A general game system only includes a device for receiving coins which are a monetary unit corresponding to the initial fee. Therefore, in some cases, it is difficult to collect a fee in a monetary unit less than the monetary unit of the initial fee. In contrast, when the electronic payment device is used, it is possible to easily collect the fee in the minimum monetary unit only by providing an input device and a reading device necessary to exchange and acquire electronic information. Therefore, when the collection of a fee for playing the game in the replay range can be implemented only by the electronic payment device, it is possible to set the replay range to be more finely than the range corresponding to the initial fee, it is preferable.

A computer program for a game system according to the present invention is a computer program for a game system comprising a charging device that collects a play fee from a user, wherein the computer program is configured to cause a computer incorporated in the game system to serve as; a game control device that allows the user to play a game in a predetermined range when the charging device collects an initial fee from the user; a replay range setting device that can set a replay range limited to a portion of the predetermined range; a replay fee setting device that sets a play fee necessary for playing the game in the replay range; an adjusting device that changes any one setting of the replay range set by the replay range setting device and the play fee set by the replay fee setting device according to the other setting of the replay range and the play fee; and a replay processing device that performs a replay process for allowing the user to play the game in the replay range set by the replay range setting device after the game is over in the predetermined range, on condition that the charging device collects the play fee set by the replay fee setting device from the user.

The computer program according to the present invention can achieve the game system according to the present invention by being executed by the computer of the game system.

### Advantageous Effects of Invention

As described above, according to the present invention, there is provided the adjusting device which changes one of the replay range set by the replay range setting device and the play fee set by the replay fee setting device according to the other of the replay range and the play fee. Therefore, even when the replay range is set to a portion of the played range, it is possible to match the replay range with the replay fee.

### BRIEF DESCRIPTION OF DRAWINGS

FIG. 1 is a diagram illustrating the overall structure of a game system according to an embodiment of the invention.

FIG. 2 is a functional block diagram illustrating the game game.

FIG. 3 is a diagram illustrating the structure of quiz data.

FIG. 4 is a flowchart illustrating a quiz control routine.

FIG. 5 is a flowchart illustrating a process during review.

### DESCRIPTION OF EMBODIMENTS

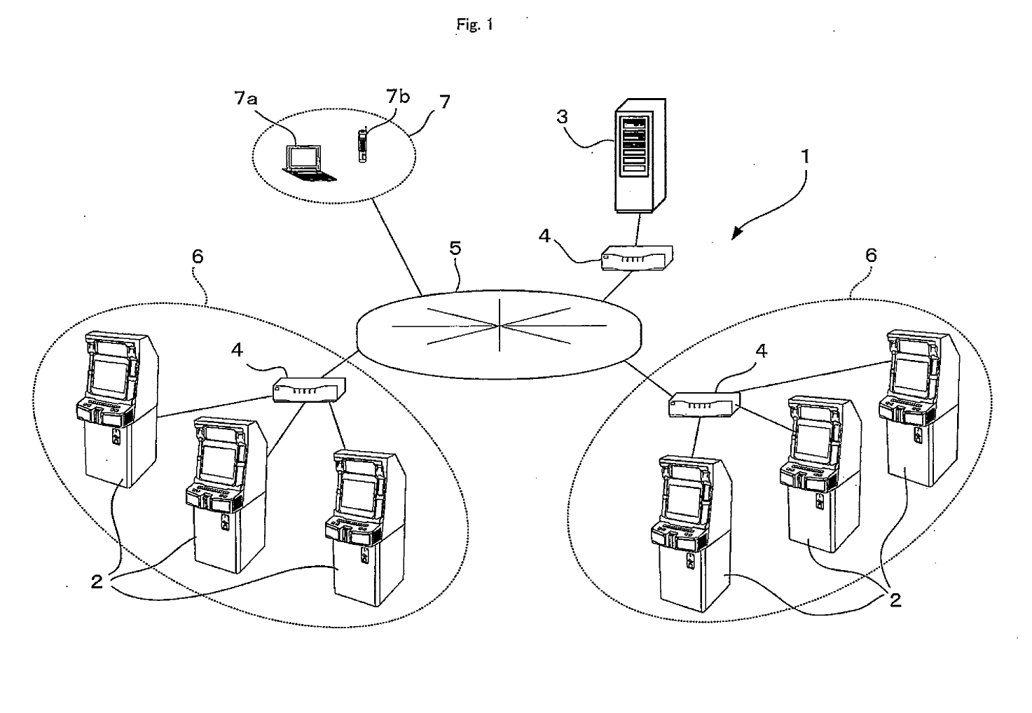

FIG. 1 shows a game system according to an embodiment of the invention. A game system 1 according to the embodiment enables the user to play a quiz game for fee and review at least a portion of the played quiz game with the payment of an additional play fee in exchange. In the game system 1, game machines (corresponding to game terminals) 2 and a center server 3 are respectively connected to a network 5 through routers 4. For example, the center server 3 includes one physical device. However, one logical center server 3 may be configured with a server group including physical devices. Further, one game machine 2 may also be used as the center server 3. The network 5 performs network communication using a TCP/IP protocol, and typically, the Internet may be used as the network 5. Each of the game machines 2 is a business or commercial game machine which collects a play fee as a game value. An appropriate number of game machines 2 are installed in a commercial facility, such as a store 6. The router 4 is provided so as to correspond to each store 6 and the center server 3, and the game machines 2 in the same store are connected to the network 5 through the common router 4. A local server may be installed between the game machines 2 and the router 4 in the store 6, and the game machines 2 may be connected to the center server 3 through the local server so as to communicate with the center server 3.

The center server 3 is installed by an operator of the game system 1 and provides various services to the game machine 2 or the user (player) of the game machine 2 through the network 5. For example, the center server 3 provides services such as a service for updating a game program or data through the game machine 2, a service for authenticating the user of the game machine 2 and storing player data including the play history of the user, sub-data in the center server 3 or the like, and a service for matching the users when the users play the game in competition or cooperation with each other through the network 5.

Unique IP addresses for identification on the network 5 are given to the game machines 2 and the center server 3. The IP address is used to specify the communication partner in the communication between the game machines 2 or between the game machine 2 and the center server 3. When the network 5 is a public network, such as the Internet, a fixed address which is unique on the network 5 is set to each router 4. A private address for uniquely identifying the game machine 2 on the network 5 by combining with the fixed address is set as the IP address to the game machine 2. In this case, a virtual private network (VPN) is established between the game machine 2 and the center server 3 or between the game machines 2, and the private address is used to uniquely specify each game machine 2 on the VPN.

The center server 3 functions as a Web server which provides services to the user terminal 7 which is accessed through the network 5, in addition to the function of providing various services to the game machine 2. The user terminal 7 may be any terminal which can be connected to the network, such as a personal computer (hereinafter, referred to as a PC) 7a or a mobile phone 7b.

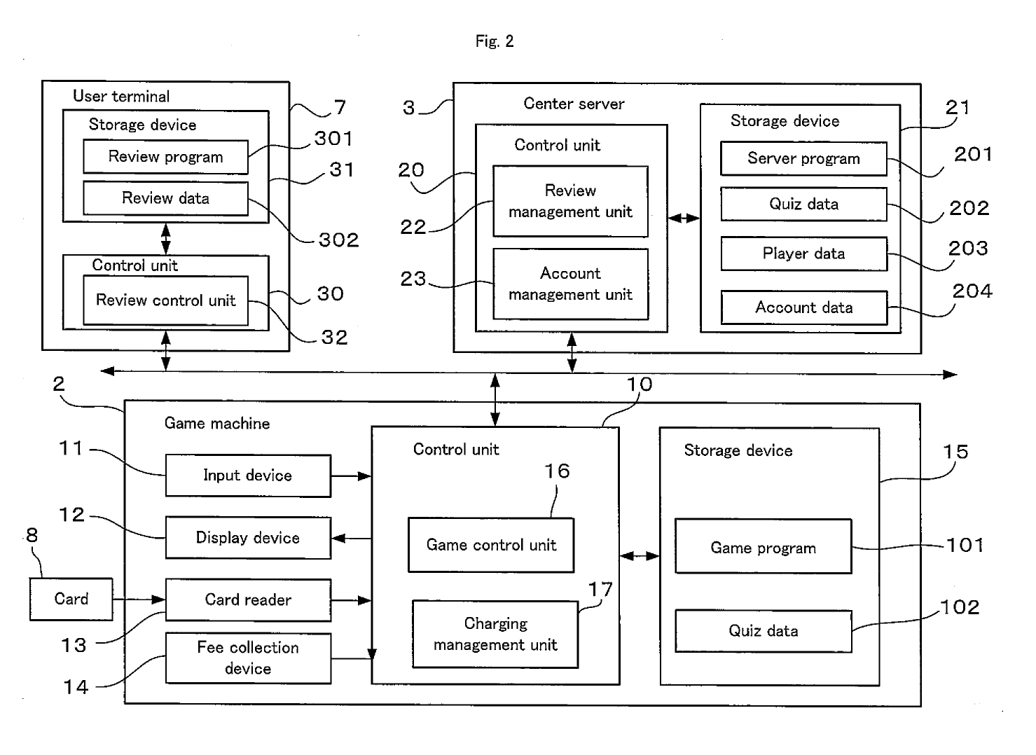

Next, the structure of the game system 1 will be described in detail with reference to FIG. 2. First, the game machine 2 is provided with a control unit 10. An input device 11, a display device 12, a card reader 13, a fee collection device 14, and a storage device 15 are connected to the control unit 10. The input device 11 receives the operation of the user and outputs a signal corresponding to the content of the operation to the control unit 10. The display device 12 displays a game screen etc. in response to instructions from the control unit 10. The card reader 13 reads information about a card 8 of the user and outputs a signal corresponding to the information to the control unit 10. The card 8 is provided with a non-volatile storage medium (not illustrated), such as an IC chip and a magnetic strip. For example, the ID (hereinafter, referred to as a card ID) which is unique with respect to each card 8 is recorded on the medium. In addition, the card ID may be recorded in the embodiment of a bar code or the like on the card 8. The fee collection device 14 detects the amount of money (coins or notes) input by the user and outputs a signal corresponding to the amount of money to the control unit 10. The storage device 15 is a storage device capable of storing and holding data, such as a hard disk storage device. The storage device 15 stores various kinds of data, such as a game program 101 which allows the control unit 10 to execute a predetermined quiz game, and quiz data 102 which is referred to by the game program 101 to play the quiz game.

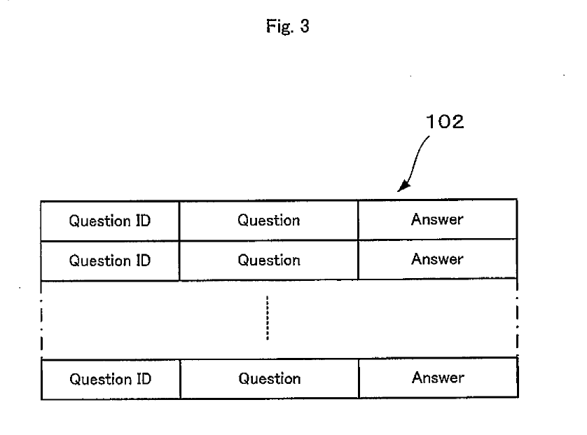

As illustrated in FIG. 3, in the quiz data 102, questions and answers of the quiz game played by the game machine 2 are associated with the question ID which is unique with respect to each question. For example, character strings, images, or the like may be appropriately combined with each other to configure the questions and answers. Although not illustrated in the drawings, the quiz data 102 may include information indicating the genre and the degree of difficulty of the question as information used when the question is selected.

Returning to FIG. 2, when the control unit 10 reads the game program 101 from the storage device 15 and executes the game program 101, a game control unit 16 and a charging management unit 17 are provided as logical devices in the control unit 10. The game control unit 16 performs various processes required to play the game, such as a process of managing the start, progress, and end of the game which is provided to the user by the game machine 2. The charging management unit 17 performs a process related to the payment of the play fee, such as a process of requesting the user to pay for the play fee and determining whether or not the requested amount of the play fee is paid. In addition, in this embodiment, it is possible to select, as a device that pays for the play fee (payment method), a method of paying for the play fee in cash using the fee collection device 14 and a payment method of withdrawing electronic money from the account managed in the center server 3. However, the minimum unit of payment (minimum amount of money) in the payment method in electronic money is less than that in the payment method in cash. For example, 100 yen is the minimum unit in the payment method in cash while one yen is the minimum unit in the payment method in electronic money.

The center server 3 is provided with a control unit 20 and a storage device 21. The control unit 20 is a computer unit including a microprocessor and internal memory devices (not illustrated) including, for example, a ROM which stores a program such as an operating system to be executed by the microprocessor, and a RAM which provides a work area to the microprocessor. An input device such as a keyboard, and an output device such as a monitor are connected to the control unit 20, which are not illustrated. The storage device 21 stores a server program 201 to be executed by the control unit 20 and various kinds of data which are referred to by the program 201. As kinds of data to be referred to by the control unit 20, for example, quiz data 202, player data 203, and account data 204 are stored in the storage device 21. The quiz data 202 is the same as the quiz data 102 illustrated in FIG. 3.

The player data 203 is a set of records in which information about the content of the played game, such as the play history and score of the player (user), is recorded so to be associated with the ID of the card 8 of the player. The account data 204 is a set of records in which the amount of the electronic money of the user is recorded so as to be associated with the unique ID of the user (hereinafter, referred to as a user ID). One card ID corresponds to one user ID, or two or more card IDs correspond to one user ID. The storage device 21 of the center server 3 also stores data for distinguishing the correspondence between the IDs. The user can increase (deposit) the amount of electronic money included in the account data 204 through, for example, the Web site managed by the system operator. Through a payment device such as a credit card, there is executed the charge to the user for the deposit of electronic money separately. Or, for example, a dedicated terminal for depositing electronic money may be used to deposit electronic money which will be exchanged with cash. The deposit of electronic money to the account data 204 and the payment thereof may be the same as those in a prepaid electronic money system, and the detailed description thereof will be omitted.

When the control unit 20 reads and executes the server program 201 in the storage device 21, a review management unit 22 and an account management unit 23 are provided as logical devices in the control unit 20. The review management unit 22 performs a process required to provide a quiz game review service to the user in response to a request from the user terminal 7. The account management unit 23 handles a process related to the management of electronic money, such as a process of withdrawing designated amount of electronic money from a corresponding record of the account data 204 in response to a request to withdraw the play fee from the game machine 2. That is, when the game machine 2 requests a withdrawal process with the card ID and the amount of payment, the account management unit 23 specifies the record corresponding to the card ID from the account data 204, and subtracts the amount of payment from money in the specified record. In this way, the payment of the play fee in electronic money is completed.

The user terminal 7 is provided with a control unit 30 and a storage device 31. The control unit 30 is a computer unit including a microprocessor and internal memory devices (not illustrated) including, for example, a ROM which stores a program such as an operating system to be executed by the microprocessor, and a RAM which provides a work area to the microprocessor. An input device such as a keyboard and an output device such as a monitor are connected to the control unit 30, which are not illustrated. The storage device 31 stores a review program 301 necessary for causing the control unit 30 to execute the review the quiz game, and review data 302 which is referred to by the review program 301. The review program 301 and the review data 302 are downloaded from the center server 3 by a Web access function of the user terminal 7, or read from a storage medium, such as CD or DVD, to the user terminal 7, and thereby stored in the storage device 31.

When the control unit 30 reads and executes the review program 301 in the storage device 31, a review control unit 32 is provided as a logical device in the control unit 30. The review control unit 32 performs a process necessary for achieving the review of the quiz game in cooperation with the review management unit 22 of the center server 3. In addition, in addition to the logical devices illustrated in the drawings, various logical devices may be provided in each of the control unit 10 of the game machine 2, the control unit 20 of the center server 3, and the control unit 30 of the user terminal 7, if necessary.

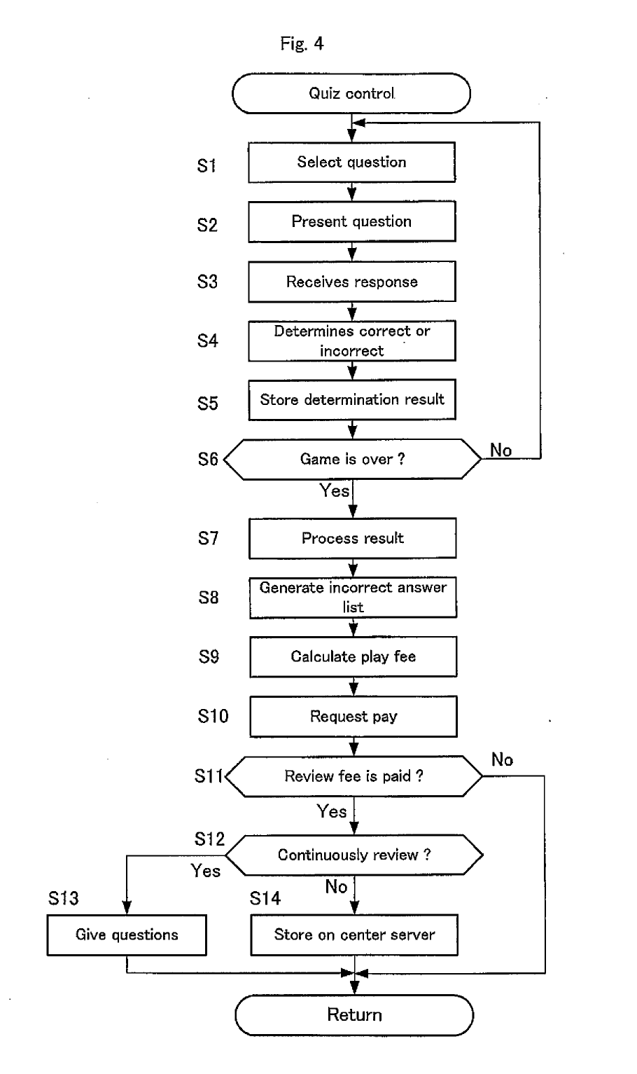

Next, the game executed by the game system 1 and the review of the game will be described. FIG. 4 shows a quiz control routine executed by the control unit 10 when the user of the game machine 2 plays the quiz game. When the user pays for a predetermined play fee (hereinafter, referred to as an initial fee) and instructs the game machine 2 to start the quiz game, the control unit 10 initiates the routine illustrated in FIG. 4. In the routine, first in Step S1, the control unit 10 selects the question ID of one question to be presented. In Step S2, the control unit 10 reads the question corresponding to the selected question ID from the quiz data 102 and presents the question to the player. In Step S3, the control unit 10 receives a response from the player. When the player inputs an answer through the input device 11, the control unit 10 proceeds to Step S4, compares the content of the answer from the player with the answer corresponding to the question ID, determines whether or not the player gives a right answer, and notifies the player of the determination that is, information indicating whether or not the answer is correct. Then, the control unit 10 proceeds to Step S5 and stores the determination result of correct or not (incorrect) so as to be associated with the question ID.

Then, the control unit 10 proceeds to Step S6, and determines whether or not the game is over. For example, when the number of questions corresponding to the prepaid play fee are given or when the game time corresponding to the play fee has elapsed, it is determined that the game is over. When it is determined that the game is not over, the control unit 10 returns to Step S1 and selects the next question. The questions are sequentially given by repeating Steps S1 to S6.

When it is determined in Step S6 that the game is over, the control unit 10 proceeds to Step S7, and processes the result of the current game. For example, the control unit 10 calculates, as the result of the game, the number of correct answers from the player, a correct answer rate, or the score of the game with reference to the determination result stored in Step S5 for the period from the start of the game to the time when the game is over. The calculated result is presented to the player or it is stored as a portion of the play history in the player data. Then, the control unit 10 proceeds to Step S8 and generates an incorrect answer list. This process is a process for generating a list of the question IDs of the questions that the player got wrong, among the questions given for the period from the start of the game to the time when the game is over.

When the incorrect answer list is generated, the control unit 10 proceeds to Step S9 and calculates a play fee necessary for review as a review fee on the basis of the incorrect answer list. For example, the review fee is calculated by multiplying the number of questions in the incorrect answer list by a unit cost per question. For example, when one question costs 2 yen and twenty questions are included in the incorrect answer list, the review fee is 40 yen. The review fee may be the sum of a base fee which is constant regardless of the number of questions and a metered fee which varies depending on the number of questions. In addition, when the player gets all questions wrong, it is preferable that the review fee be set to be less than the initial fee.

When the review fee is calculated, the control unit 10 proceeds to Step S10 and requests the player to pay for the review fee. In this case, as the payment method, a payment method in electronic money is requested. This is because when the payment method in cash is used, a fraction of the review fee is not paid since the minimum unit is more than a fraction of the review fee. Then, in Step S11, the control unit 10 determines whether or not the review fee is paid in electronic money. When the fee is paid, the control unit 10 proceeds to Step S12 and inquires the player whether to continuously review the game on the game machine 2. When the player requests to continuously review the game, the control unit 10 proceeds to Step S13 and performs the review on the basis of the incorrect answer list. That is, the control unit 10 sequentially gives the questions with the question IDs in the incorrect answer list, acquires answers to the questions from the player, and determines whether or not the answers are correct. When the process of giving all of the questions in the incorrect answer list and determining whether the answers are correct ends, the control unit 10 ends the current quiz control routine. In this case, the number of reviews is limited to one.

On the other hand, when the player does not request to continuously review the game in Step S12, the control unit 10 proceeds to Step S14 and stores the incorrect answer list in the player data 203 corresponding to the user ID on the center server 3. In addition, information about the result processed in Step S7 and the incorrect answer list may be stored in the player data on the game machine 2, and the player data may be transmitted and stored in the center server 3. When Step S14 ends, the control unit 10 ends the current routine. In addition, when it is determined in Step S11 that the play fee is not paid, the control unit 10 skips Step S12 and the subsequent steps, and ends the current routine. In this case, the incorrect answer list is discarded.

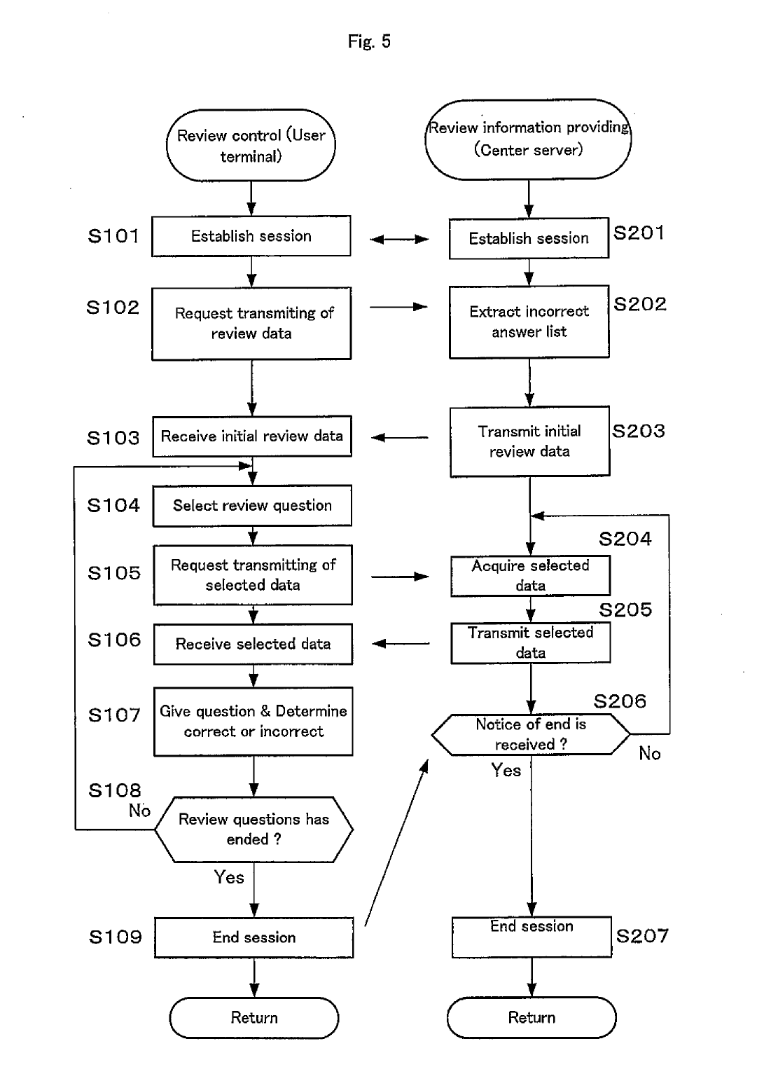

The incorrect answer list stored in the player data 203 of the center server 3 is accessed by the user terminal 7 and is used for the review of the game by the user. FIG. 5 shows the process. When the user of the user terminal 7 accesses the center server 3 through the authentication of the user ID and requests a quiz game review service using the user terminal 7, the control unit 30 of the user terminal 7 initiates the review control routine illustrated in FIG. 5. In addition, this routine is a process performed by the review control unit 32.

When the review control routine illustrated in FIG. 5 starts, first, the control unit 30 requests the center server 3 to establish a communication session in Step S101. Then, in response to the request, the control unit 20 of the center server 3 starts a review information providing routine illustrated in FIG. 5 using the review management unit 22, and establishes the session between the user terminal 7 and the center server 3 in Step S201. When the session is established, the control unit 30 of the user terminal 7 proceeds to Step S102 and requests the center server 3 to transmit the review data 302. Then, the control unit 30 proceeds to Step S103 and receives initial review data. The control unit 20 of the center server 3 proceeds to Step S202 extracts, from the player data 203, the incorrect answer list which is stored so as to be associated with the user ID (the user ID corresponding to the user of the user terminal 7) designated by the user terminal 7. Then, in Step S203, the control unit 20 transmits the initial review data including the extracted incorrect answer list to the user terminal 7.

When the control unit 30 of the user terminal 7 receives the initial review data from the center server 3, the control unit 30 proceeds to Step S104 and selects one of the question IDs in the incorrect answer list included in the data. Then, in Step S105, the control unit 30 requests the center server 3 so as to transmit the data of question and answer corresponding to the selected question ID as selected data. Then, the control unit 30 proceeds to Step S106 and receives the selected data from the center server 3. In Step S204, the control unit 20 of the center server 3 receives the request of Step S105, and acquires the question and answer corresponding to the requested question ID as the selected data from the quiz data 202. Then, in Step S205, the control unit 20 transmits the selected data to the user terminal 7.

After the control unit 30 of the user terminal 7 receives the selected data in Step S106, the control unit 30 stores the selected data as a portion of the review data 302 in the storage device 31. Then, in Step S107, the control unit 30 gives the question included in the selected data to the user. Further, the control unit 30 acquires answer to the given questions from the user, compares the answer with the answer in the selected data, and determines whether or not the answer of the user is correct. The determination result is presented to the user. After the determination process, the control unit 30 proceeds to Step S108 and determines whether or not the review of all of the question IDs in the incorrect answer list has ended. When it is determined that the review of all of the questions has not ended, the control unit 30 returns to Step S104. When it is determined that the review of all of the questions has ended, the control unit 30 proceeds to Step S109 and ends the session with the center server 3.

The end of the session is also notified to the control unit 20 of the center server 3. The control unit 20 of the center server 3 proceeds to Step S206 after the selected data is transmitted and determines whether or not a notice indicating the end of the session is received from the user terminal 7. When the notice indicating the end of the session is not received, the control unit 20 returns to Step S204. On the other hand, when the notice indicating the end of the session is received, the control unit 20 proceeds to Step S207 and performs a process necessary for ending the session. When processes of Steps S109 and S207 end, each of the control unit 30 of the user terminal 7 and the control unit 20 of the center server 3 ends the routine illustrated in FIG. 5. When the session ends, the control unit 30 of the user terminal 7 may or may not delete the review data 302 stored in the storage device 31. When the review data 302 is stored, it is possible to perform the review again without accessing the center server 3. Also, the control unit 20 of the center server 3 may delete the incorrect answer list in the player data 203 when the session ends. When the control unit 20 deletes the incorrect answer list and the control unit 30 deletes the review data 302, the number of reviews by the user terminal 7 is limited to one.

In the above-described embodiment, a combination of the card reader 13, the fee collection device 14, and the charging management unit 17 functions as a charging device and the control unit 10 functions as a game control device. Also, the control unit 10 functions as a replay range setting device by performing Step S8 in FIG. 5, functions as a replay fee setting device and an adjusting device by performing Step S9, and functions as a replay processing device by performing Steps S11 to S14. In the above-described embodiment, one question and an answer to the one question correspond to the unit of the game, and the review by the game machine 2 or the user terminal 7 corresponds to a replay.

The invention is not limited to the above-described embodiment, but various modifications and changes of the invention can be made. For example, in the above-described embodiment, a method of paying for the play fee in electronic money is used as the electronic payment device. However, the electronic payment device may be added and changed appropriately as long as the minimum unit amount of money thereof is less than that of cash. For example, a credit card may be appropriately used to pay for the fee or the like. When electronic money is used, in the above-described embodiment, an electronic money account is opened on the center server, and electronic money corresponding to the play fee is withdrawn through the network to pay for the play fee. However, for example, the play fee may be paid by a so-called prepaid electronic money system which charges electronic money to a storage medium, such as an IC chip, provided in the card 8 or a mobile phone, and subtracts the balance of the electronic money on the card 8 in accordance with the play fee. When the prepaid electronic money system is used, the electronic money account may be managed by a server different from the center server for executing the game, for example, the play fee may be paid by an electronic money payment system provided by an external provider.

The invention is not limited to the execution of the quiz game, but can be applied to appropriate kind of games. For example, in a game system in which concept of a stage and the like is considered as the unit of the game and the game is played for each unit, a unit with a relatively low score may be extracted and involved in the replay range, and a replay fee suitable for the replay range may be set. The invention is not limited to the example in which the replay range is set on the basis of the score, but the replay range may be set in response to an instruction from the player. Or, the game system may be modified such that, before the replay range is set, a play fee for replay is set by the player and the replay range is set according to the set range. That is, when one of the replay range and the play fee for replay is set, the adjusting device according to the invention may set the other according to the setting of one of the replay range and the play fee for replay.

The game system according to the invention is not limited to the network game system in which the game terminal and the center server are connected to each other through the network, but the invention may be applied to a game system including a so-called stand-alone game terminal which is not connected to the network. Also, in the above-described embodiment, the game terminal is provided in the store, but the invention is not limited thereto. For example, as the game system according to the invention, there may be constructed any game system which includes a home-use game machine or a mobile phone as a game terminal as far as the game system can execute the process of pay for a play fee and enables the player to play a game for fee through the network.

### Reference Signs List

### 1: GAME SYSTEM

### 2: GAME MACHINE (GAME TERMINAL)

### 3: CENTER SERVER

### 5: NETWORK

### 6: STORE

### 7: USER TERMINAL

### 10: CONTROL UNIT (GAME CONTROL DEVICE, REPLAY RANGE SETTING DEVICE)

### 13: CARD READER (CHARGING DEVICE)

### 14: FEE COLLECTION DEVICE (CHARGING DEVICE)

### 17: CHARGING MANAGEMENT UNIT (CHARGING DEVICE)

101: GAME PROGRAM

1. A game system comprising:
a charging device that collects a play fee from a user;
a game control device that allows the user to play a game in a predetermined range when the charging device collects an initial fee from the user;
a replay range setting device that can set a replay range limited to a portion of the predetermined range;
a replay fee setting device that sets a play fee necessary for playing the game in the replay range;
an adjusting device that changes any one setting of the replay range set by the replay range setting device and the play fee set by the replay fee setting device according to the other setting of the replay range and the play fee; and
a replay processing device that performs a replay process for allowing the user to play the game in the replay range set by the replay range setting device after the game is over in the predetermined range, on condition that the charging device collects the play fee set by the replay fee setting device from the user.

2. The game system according to claim 1, wherein the game control device is configured to advance the game in the predetermined range by a predetermined unit,
the number of units of the game in the replay range is set so as to be less than the number of units of the game in the predetermined range, and
the adjusting device changes the one setting according to the other setting such that an increase in the number of units in the replay range corresponds with an increase in the play fee set by the replay fee setting device.

3. The game system according to claim 2, further comprising a result evaluating device that evaluates a play result for each unit, and wherein
the replay range setting device extracts a unit with a relatively low score from the units of the game included in the predetermined range and sets the replay range, and
the replay fee setting device functions as the adjusting device by increasing or decreasing the play fee according to the replay range set by the replay range setting device.

4. The game system according to claim 2, wherein the game is configured as a quiz game which uses a question and an answer of a player as the unit and progresses by the unit,
the replay range setting device extracts the unit in which the answer of the player is incorrect from the units of the game included in the predetermined range and sets the replay range, and
the replay fee setting device functions as the adjusting device by increasing the play fee with increasing the number of units included by the replay range setting device.

5. The game system according to claim 4, wherein the replay processing device performs, as the replay process, a process of giving the questions included in the replay range to the player.

6. The game system according to claim 1, wherein the charging device and the game control device are provided in a game terminal, and
the replay processing device performs a process of allowing the player to play the game in the replay range on the game terminal as the replay process.

7. The game system according to claim 1, wherein the charging device and the game control device are provided in a game terminal,
the game terminal is connected to a server through the network,
a user terminal different from the game terminal can be connected to the server through the network, and
the replay processing device performs, as the replay process, a process for allowing the user terminal to be able to play the game in the replay range.

8. The game system according to claim 1, wherein the charging device collects the play fee using an electronic payment device that can replace a cash payment device, and achieves the collection of the play fee set by the replay fee setting device only by use of the electronic payment device.

9. A storage medium storing a computer program for a game system comprising a charging device that collects a play fee from a user, wherein the computer program is configured to cause a computer incorporated in the game system to serve as;
a game control device that allows the user to play a game in a predetermined range when the charging device collects an initial fee from the user;
a replay range setting device that can set a replay range limited to a portion of the predetermined range;
a replay fee setting device that sets a play fee necessary for playing the game in the replay range;
an adjusting device that changes any one setting of the replay range set by the replay range setting device and the play fee set by the replay fee setting device according to the other setting of the replay range and the play fee; and
a replay processing device that performs a replay process for allowing the user to play the game in the replay range set by the replay range setting device after the game is over in the predetermined range, on condition that the charging device collects the play fee set by the replay fee setting device from the user.
